(19) United States
(12) Patent Application Publication
(10) Pub. No.: US 2016/0159358 A1
(43) Pub. Date: Jun. 9, 2016

(54) Neutral-Stop System for Vehicles

(71) Applicant: Pallant Satnarine Ramsundar, Chester, VA (US)

(72) Inventor: Pallant Satnarine Ramsundar, Chester, VA (US)

(21) Appl. No.: 14/563,173

(22) Filed: Dec. 8, 2014

(51) Int. Cl. B60W 30/18; B60W 10/10

(52) U.S. Cl. CPC B60W 30/18109; B60K 41/26; B60W 2520/04; B60W 2510/0208; B60W 2510/101; B60W 2710/18

(57) ABSTRACT

A system which when switched on, automatically keeps a vehicle from rolling when the transmission is placed in the neutral position. The system frees a driver from having to manually activate a vehicle braking system in such a situation.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

This invention is in the field of vehicle control systems. More specifically, this invention provides specific control functions to be applied to transmissions to effect vehicle immobility under certain conditions, when the transmission is in the neutral position.

### BACKGROUND OF THE INVENTION

When a motor vehicle is brought to a stop, as for example at a red traffic signal or in a traffic jam, the driver must engage in one of the following options to keep the vehicle at a standstill:
a) For an automatic transmission, the driver may keep the brake pedal depressed while the transmission is in a drive mode, until he/she is ready to move the vehicle.
b) For an automatic transmission, the driver may alternatively put the transmission in a neutral position and rest his/her feet on the floor of the vehicle.
   If the roadway has a grade which may cause the vehicle to roll, the driver may additionally have to either engage the parking brake or depress the brake pedal. In engaging the brake pedal the driver can no longer rest his/her feet on the floor of the vehicle and in the case where the parking brake was engaged, it must be disengaged to move the vehicle.
c) For a manual transmission, the driver may keep both the brake pedal and the clutch pedal depressed while the transmission is in a drive mode, until he/she is ready to move the vehicle.
d) For a manual transmission, the driver may alternatively put the transmission in a neutral position and rest his/her feet on the floor of the vehicle.
   If the roadway has a grade which causes the vehicle to roll, the driver may additionally have to either engage the parking brake or the brake pedal. In engaging the brake pedal the driver can no longer rest his/her feet on the floor of the vehicle and in the case where the parking brake was engaged, it must be disengaged to move the vehicle.

This invention provides a means of automatically holding a vehicle at a stand-still when the transmission is placed in the neutral position, without any manual additional engagement of the vehicle braking systems. This function is not commercially available as described, but other systems involving transmissions and vehicular braking systems have been proposed and principal patents in this field are as follows:
i. U.S. Pat. No. 4,526,065 filed in 1982 for Stanley D. Rosen and William D. Ross describing the use of a torque converter and planetary gearing to interrupt the driving connection below a preset speed.
ii. U.S. Pat. No. 5,094,077 filed in 1990 for Hideaki Okada describing a hydrostatic transmission system axle driving apparatus to allow the vehicle to be started at slow speed, but not abruptly.
iii. U.S. Pat. No. 4,051,915 filed in 1976 for Robert Nick Behrens describing electric control circuitry to prevent a tractor engine from being started with the tractor transmission or power take-off engaged and for preventing the tractor from being driven with the park brake engaged.
iv. U.S. Pat. No. 5,272,630 filed in 1992 for Larry T. Brown and Marvin P. Kraska describing an automatic transmission for disengaging the forward-drive clutch when the vehicle is stopped and the vehicle engine is idling and provision for minimizing inertia torque disturbances when the clutch is engaged upon the initiation of the vehicle acceleration mode from a standing start.
v. U.S. Pat. No. 3,868,003 filed in 1973 for Kenneth Smith describing a foot pedal to reset some hydraulic transmissions in a neutral position.
vi. U.S. Pat. No. 5,617,936 filed in 1995 for Shusuke Nemoto describing a transmission design incorporating a brake mechanism.
vii. U.S. Pat. No. 4,355,698 filed in 1990 for Charles A. Barnes, Dean E. Davis and Carl L. Wykoff describing a control system to activate the parking brake and place the transmission in neutral when a driver leaves his seat.
viii. U.S. Pat. No. 5,167,308 filed in 1991 for Charles Osborn describing a locking mechanism in which the shifting lever is locked in a park lock position until certain actions are taken.
ix. U.S. Pat. No. 3,709,344 filed in 1971 for Gerald E. Sieren describing a control system in which a lever sequentially disengages an clutch and activates a transmission brake while operating a neutral safety switch and providing increased brake pedal force.
x. U.S. Pat. No. 4,105,101 filed in 1976 for Hans-Joachim Forster and Ulrich Eltze describing a drive arrangement for adjusting the idling rotational speed.
xi. U.S. Pat. No. 3,601,231 filed in 1969 for Ferdynand Kolacz and Donald W. Longshore describing a vehicle mechanism for operating a parking brake with an interlock to prevent shifting into a driving ratio or starting of the engine.
xii. U.S. Pat. No. 5,052,531 filed in 1990 for Keiji Bota describing a device that maintains brake action at start even if the brake pedal is released.
xiii. U.S. Pat. No. 6,484,497 filed in Feb 24, 2000 for Norman E. Jolliff and Richard T.

Ruebusch describing a hydraulically-released, spring-activated brake mechanism activated when a hydrostatic transmission is placed in neutral.

### BRIEF SUMMARY OF THE INVENTION

The present invention is a control system that sends a signal to actuate a braking system of a powered vehicle, providing that the transmission is in the neutral position and the vehicle is at a complete stop. The present invention allows drivers to shift their transmission into neutral and simultaneously prevent the vehicle from moving, with no additional manual intervention to provide vehicle braking.

In one aspect of the invention there is provided a means to activate or inactivate the system.

In another aspect of the invention, specific states of the transmission and the vehicle motion signals a selected braking system or systems of the vehicle to be engaged.

In another aspect of the invention, the status of various components affected by the invention is indicated or displayed.

In another aspect of the invention, a time delay to disengage the system is instituted to allow the transmission some time to accommodate to a new transmission position.

### BRIEF DESCRIPTION OF DRAWINGS

FIGS. 1 to 5 are flow charts for the operation of the present invention. FIGS. 1 to 3 show the process of engagement of the system while FIGS. 4 and 5 show alternatives as the system is disengaged.

### DETAILED DESCRIPTION OF THE INVENTION

The present invention is a control mechanism that can be achieved by modifying on-board vehicle control systems or by implementing additional control components or a mix thereof.

The present invention is powered by the electrical system of the powered vehicle and would require the ignition or Power switch to be turned on. When the ignition or Power switch of the powered vehicle is turned off the ‘Neutral-Stop System’ described in this invention, will be inactive. The description below applies to the situation where the ignition or Power switch of the powered vehicle is turned on, the power plant of the vehicle is running and the ‘Neutral-Stop System’ is receiving electrical power from the vehicle.

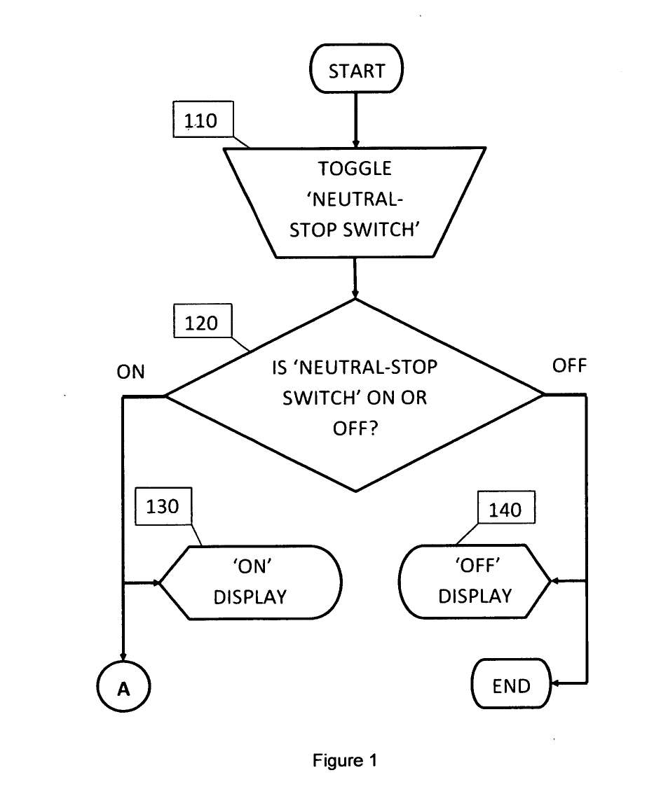

Referring to FIG. 1, the present invention is a system that must be further activated by a switch called the ‘Neutral-Stop Switch’ shown in block 110 in FIG. 1. The status of the ‘Neutral-Stop Switch’ is indicated by way of the displays shown by blocks 130 and 140 in FIG. 1. If the Neutral-Stop Switch is in the ‘off’ position the invention will have no effect on the vehicle.

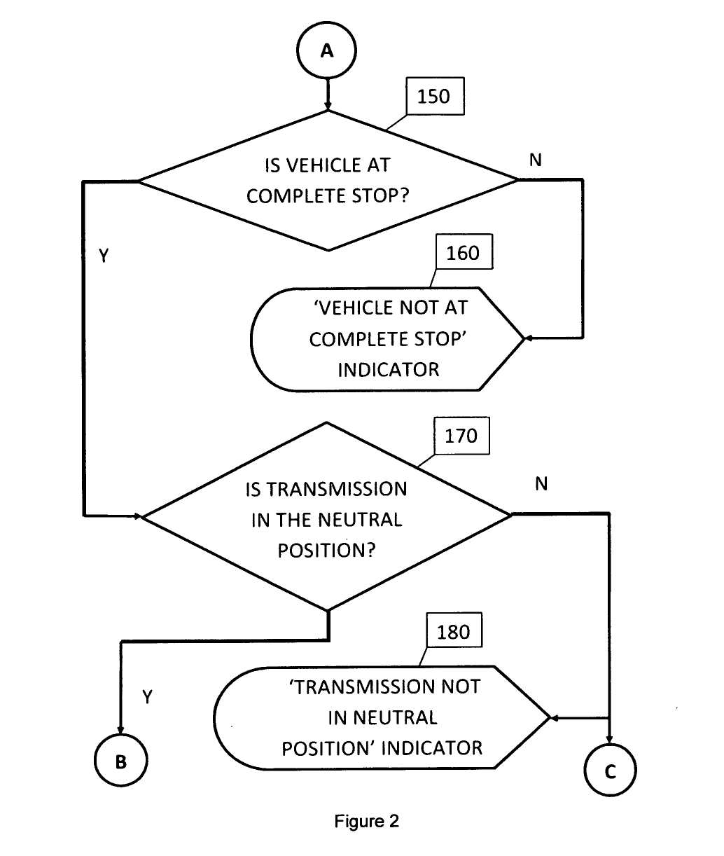

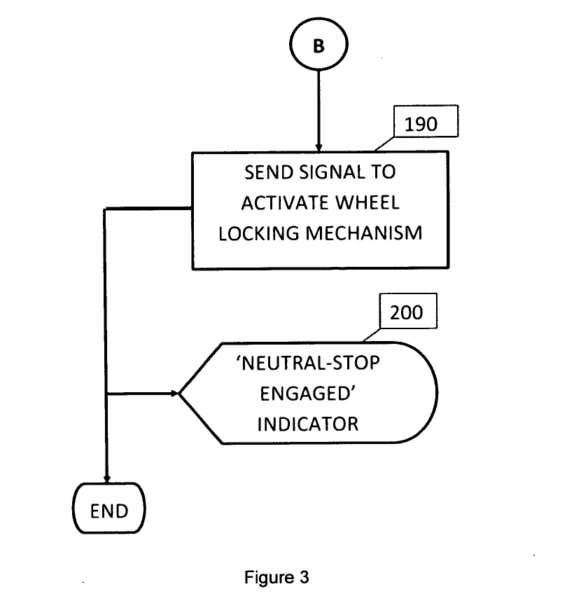

When the Neutral-Stop Switch is ‘on’ the present invention is a system that checks two conditions as shown in FIG. 2. The first condition, represented in Block 150, is whether the vehicle is at a complete stop and the second condition, represented in Block 170, is whether the transmission is in the neutral position. Once both conditions are met, an output signal is sent to actuate a wheel-locking mechanism of the vehicle. Should any of the conditions represented by Blocks 150 and 170 be negative, no signal will be sent to the wheel locking mechanism and the invention will have no effect on the vehicle. Displays represented by Blocks 130, 140, 160, 180, 200, 230 and 260 indicate the status of the different components affecting the invention and one or more may be included in the system as desired. The actual description or display content represented by blocks 130, 140, 160, 180, 200, 230 and 260 can be varied as desired.

The wheel locking mechanism is without limitation, and can be any desirable system on the vehicle, such as the wheel braking pads, the emergency brake, transmission locks or other additional wheel-locking systems specifically designed to keep the vehicle from moving.

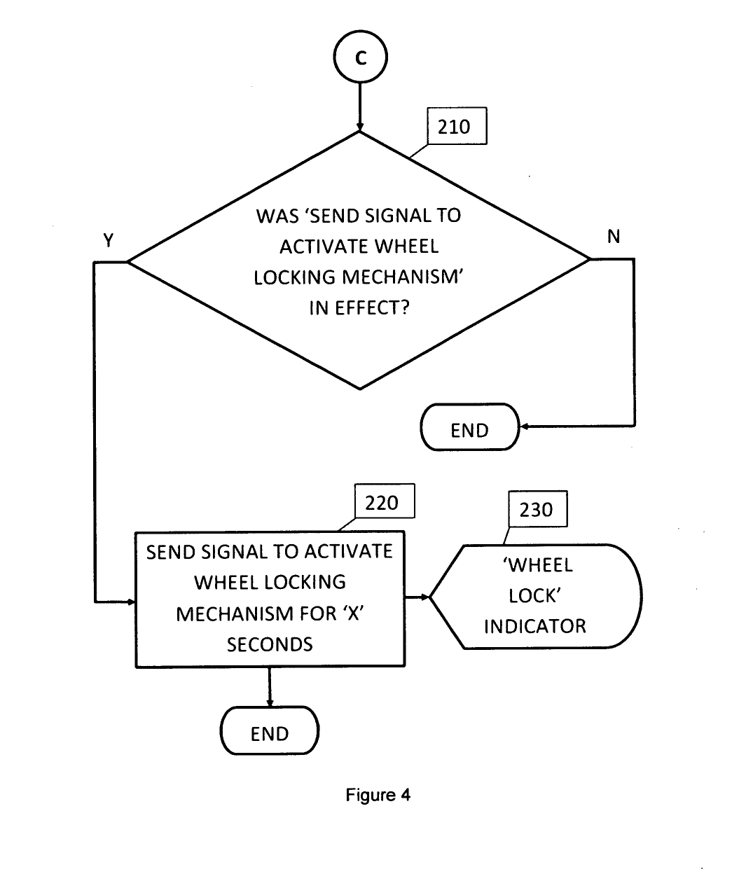

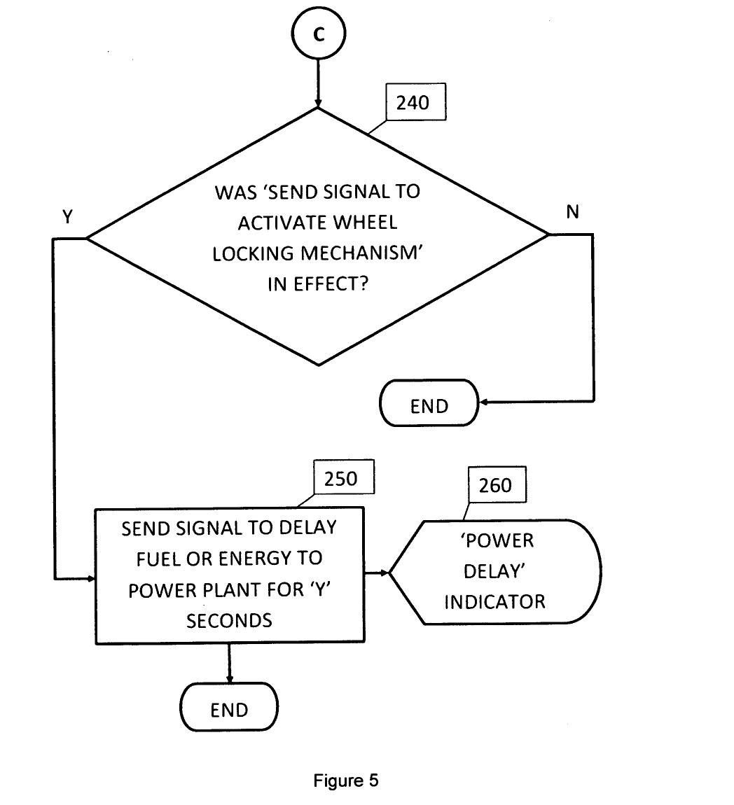

Also included as part of this invention is provision for controlled disengagement after the invention has activated a braking system of the vehicle. This is illustrated in FIGS. 4 and 5. If a braking system has been activated and the transmission is shifted out of the neutral position, two alternatives are provided and may be incorporated individually, together or not at all. One alternative is to keep the braking system active for a period of time denoted by ‘X’ as shown in block 220, while the other alternative is to delay additional fuel flow or energy to the power plant of the vehicle for a period of time denoted by ‘Y’. This is to allow the transmission some time to compensate for any backlash in the system or other actuation delays to accommodate a new transmission position. The time delay is to be set to suit the behavior of the particular transmission system to which the invention is applied.

The advantages of the present invention, without limitation, are:
a) It keeps a vehicle from rolling when the transmission is placed in the neutral position.
b) Frees the driver from manually actuating a braking system when the transmission is placed in the neutral position.
c) Relieves driver tedium in having to keep the brake pedal depressed for extended periods, when the vehicle is stopped.
d) Can be added to existing vehicles and if switched off, will not affect the operation of the vehicle as originally designed.
e) May provide energy saving and reduced fuel consumption, over vehicles with transmissions in the drive positions which are maintained in a stop position by use of the brake pedal or the emergency brake.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A process to keep a running vehicle from moving without driver intervention when the transmission is in the neutral position.

2. The process of claim 1, wherein the invention draws power from a running vehicle and signals components of the vehicle and/or added components to effect desired actions.

3. The process of claim 1, wherein the invention can be turned off to have no effect on the vehicle.

4. The process of claim 1, wherein the invention will act on a vehicle only if the transmission is placed in the neutral position with the vehicle stopped.

5. The process of claim 1, wherein the invention, once activated will stay engaged until the transmission is disengaged from the neutral position or the system is turned off.

6. The process of claim 1, wherein the invention displays conditions of the state of various items relevant to the invention.

7. The process of claim 1, wherein once the invention has activated a braking system of the vehicle, the disengagement from the neutral position provides a time delay, to give the transmission time to compensate for any backlash in the system or other actuation delays, to accommodate a new transmission position.
